(19) United States
(12) Patent Application Publication
(10) Pub. No.: US 2009/0250040 A1
(43) Pub. Date: Oct. 8, 2009

(54) Method For Improving Combustion Efficiency

(76) Inventors: Wen-Hsiung PAN, Taipei City (TW); Kuan-Yu PAN, Teipei City (TW)

Correspondence Address: FRENKEL & ASSOCIATES, 3975 UNIVERSITY DR., STE. 330, FAIRFAX, VA, 22030, US

(21) Appl. No.: 12/061,017

(22) Filed: Apr. 2, 2008

(51) Int. Cl. F02B 43/04

(52) U.S. Cl. 123/543

(57) ABSTRACT

A method for improving combustion efficiency as combusting a pure substance is disclosed. The method is started from deciding an environmental temperature of a combustion environment, setting a first temperature higher than the environmental temperature, and uniformly heating the pure substance to the first temperature so as to shorten the temperature drop between the outer surface and the inner portion of the pure substance as far as possible. Simultaneously, after a combustion-supporting gas is provided and heated to a second temperature and the combustion-supporting gas is supplied to the combustion environment, the pure substance is ignited. The steps described above can accelerate the temperature raising as combusting the pure substance, so as to be more close to complete combustion, thereby improving efficiency and reducing contaminant production.

### FIELD OF THE INVENTION

The present invention is related to a method for improving combustion efficiency, and more particularly to a method for combusting a pure substance.

### BACKGROUND OF THE INVENTION

Since human discovers the fire, combustion has already become the most important event in human culture. In modern times, after the industrial revolution, steam engine, external-combustion engine and internal-combustion engine almost predominate over the culture improvement and even in chemical processing and waste processing, the combustion procedure also involves directly or indirectly. As combustion, temperature and efficiency are key factors in combustion procedure. The combustion efficiency of pure substance (which is a compound composed of single kind or multiple kinds of chemical elements) is decided by if the oxidization ratio of the substance to be combusted can be improved and if the chemical energy produced during chemical reaction can be inverted into thermal energy. In the normal combustion environment (which usually is under 750° C.), since the atmosphere is mixed by multiple kinds of gases and the substance to be combusted will react with different gases to produce different compounds, the inversion efficiency to the thermal energy of the substance to be combusted is low, and the air also might be contaminated, for example, the combustion might produce dioxin and SO₂. The reason why the dioxin is produced is that, during combustion of most substance (or mixture), the temperature can not rapidly rise to a temperature capable of decomposing dioxin or incapable of forming dioxin (which usually at least has to reach 855° C.). However, when the substance is combusted or incinerated, it always becomes that the ignited outer surface thereof has a higher temperature and the inner portion still remains at a lower temperature. Moreover, if the substance is a mixture, the different materials therein may have different ignition points, so that the ignition of each material will be different, and the peripheral air with lower temperature might be sucked therein so as to hinder the temperature from rising. Therefore, it might cause the combustion incomplete and the temperature rising becomes slower, and further, prior to the temperature reaches 1000° C., a large amount of dioxin has already formed, so that it has to restrict the waste gas produced by incinerator to retain for a period of time for burning down 99% dioxin before exhausting. Obviously, the conventional combustion method can not effectively reduce the quantity of dioxin. Besides, since, during combustion, temperature distribution is different and combustion is incomplete, the combustion temperature and efficiency might be lowered down and the heat produced and obtained also becomes lower. For example, supposed the substance to be combusted is a coal, during combustion, the temperature difference between the outer surface and the inner portion of the coal will cause the combustion incomplete and the chemical energy can not be completely inverted into thermal energy, so that partial the chemical energy will cause the coal to react with other elements so as to produce contaminants, such as dioxin and sulfur dioxide. Consequently, the conventional combustion method is defect that the temperature can not rise up rapidly and the outer surface and the inner portion have a temperature drop therebetween.

### SUMMARY OF THE INVENTION

Therefore, the object of the present invention is to provide a combustion method of pure substance so as to improve combustion efficiency and accelerate temperature rising, thereby reducing the production of contaminant and achieving a better inversion from chemical energy to thermal energy.

The present invention provides a method for improving combustion efficiency as combusting a pure substance. The method is started from deciding an environmental temperature of a combustion environment, setting a first temperature higher than the environmental temperature, and uniformly heating the pure substance to the first temperature so as to shorten the temperature drop between the outer surface and the inner portion of the pure substance as far as possible. Simultaneously, after a combustion-supporting gas is provided and heated to a second temperature and the combustion-supporting gas is supplied to the combustion environment, the pure substance is ignited. The steps described above can accelerate the rising of temperature as combusting the pure substance, so as to be more close to complete combustion, thereby improving efficiency and reducing contaminant production.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a flow chart showing the steps of the present invention.

### DESCRIPTION OF THE PREFERRED EMBODIMENT

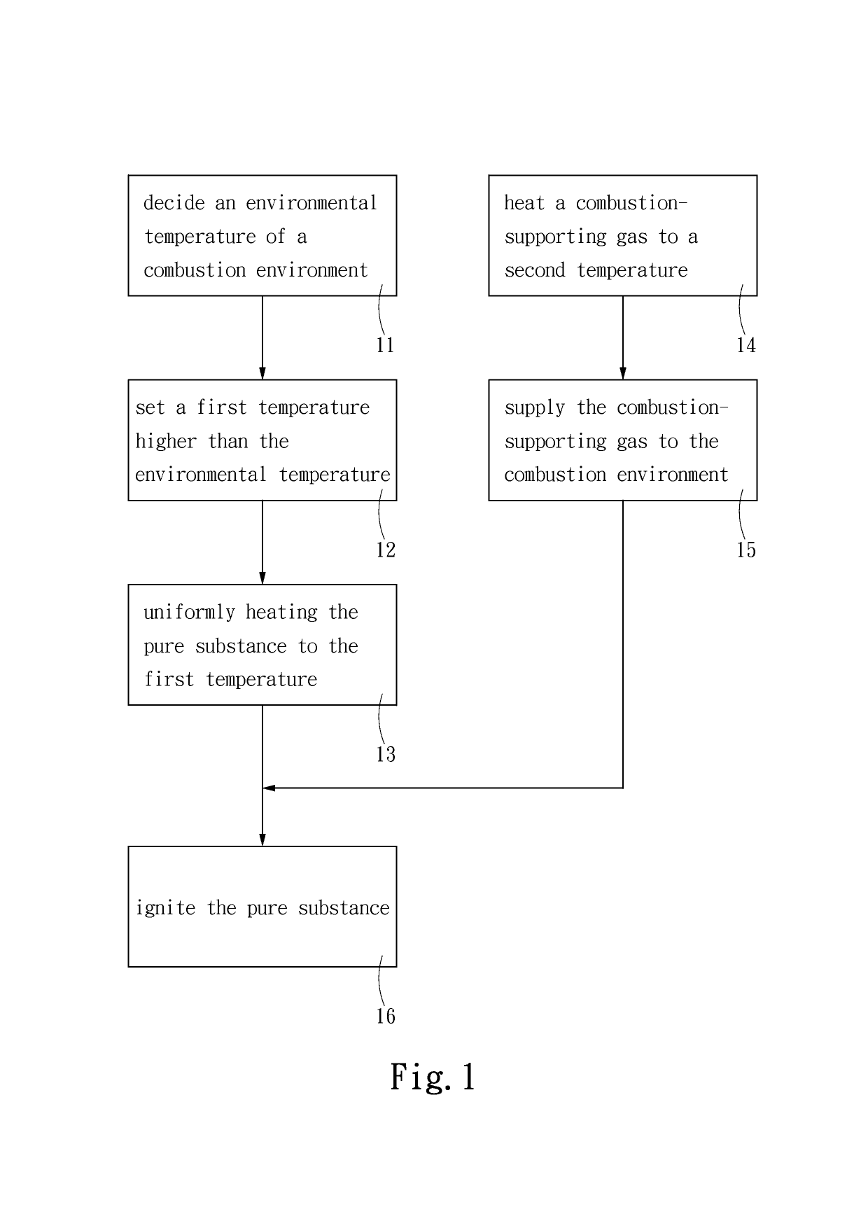

The present invention is related to a method for improving combustion efficiency as combusting a pure substance. The method includes steps of: A. deciding an environmental temperature of the combustion environment and setting a first temperature higher than the environmental temperature, B. uniformly rising the temperature of the pure substance up to the first temperature, C. providing a combustion-supporting gas, heating the combustion-supporting gas to a second temperature and supplying the heated combustion-supporting gas to the combustion environment, and D. igniting the pure substance. Since the pure substance has a temperature identical to the combustion environment before combustion, for shortening the time for the pure substance to reach the ignition point and for avoiding the temperature drop between the outer surface and the inner portion, the pure substance should be uniformly heated until the inner portion also reaches the first temperature, wherein the first temperature should be higher than the environmental temperature but lower than the ignition point of the pure temperature. In a preferred embodiment, the first temperature is set to be close to the ignition point of the pure substance as far as possible, so that the pure substance can be more close to the ignition state. Moreover, the provision of the combustion-supporting gas facilitates the last combustion step, wherein the combustion-supporting gas needs to be heated to the second temperature which is also higher than the environmental temperature, and then, the heated combustion-supporting gas is supplied to the combustion environment to distribute around the pure substance for helping combustion. Since the pure substance has already heated to the temperature close to the ignition point and the heated combustion-supporting gas also distributes around the combustion environment, after ignition, the combustion can be started fast and uniformly, and the temperature also can rise up rapidly for reducing the contaminant-generating time and also can decompose the contaminant through the high temperature. Furthermore, since the pure substance can be combusted uniformly, most of the chemical energy of the pure substance can be inverted into thermal energy during the combustion for further utilization. Therefore, through the method described above, except the contaminant can be reduced, more energy can be obtained, too. In addition, the heat needed for heating or combustion can be obtained from mechanical operation or other combustion procedures so as to sufficiently utilize the energy. Please refer to FIG. 1, which is a flow chart showing the present invention. The method is started from deciding an environmental temperature of a combustion environment 11, setting a first temperature higher than the environmental temperature 12, and uniformly heating the pure substance to the first temperature 13. Simultaneously, after a combustion-supporting gas is heated to a second temperature 14, the combustion-supporting gas is supplied to the combustion environment 15, wherein the combustion-supporting gas can be oxygen or a gas mixed by multiple kinds of gas elements. After the pure substance reaches the first temperature and the heated combustion-supporting gas sufficiently distributes the combustion environment, the pure substance is ignited 16.

In the aforesaid, through the present invention, the pure substance can be combusted fast and uniformly and the combustion temperature can rise rapidly to reduce production time of contaminant and the high temperature can decompose partial contaminant, thereby reducing the poisonous material, such as dioxin, to be produced in the air. Besides, since the pure substance can be combusted uniformly, most of the chemical energy of the pure substance can be inverted into thermal energy during the combustion for further utilization. Therefore, through the description above, the combustion efficiency of engine, such as internal-combustion engine, steam engine, and external-combustion engine, can be improved, so that the energy obtained from unit fuel (petroleum, coal, plant or) becomes more and the engine can produce more power or more power can be saved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for improving combustion efficiency as combusting a pure substance in a combustion environment, comprising steps of:
A. deciding an environmental temperature of the combustion environment and setting a first temperature higher than the environmental temperature;
B. uniformly rising the temperature of the pure substance to the first temperature;
C. providing a combustion-supporting gas, heating the combustion-supporting gas to a second temperature and supplying the heated combustion-supporting gas to the combustion environment; and
D. igniting the pure substance.

2. The method as claimed in claim 1, wherein the first temperature is lower than the ignition point of the pure substance.

3. The method as claimed in claim 1, wherein the second temperature is higher than the environmental temperature.

4. The method as claimed in claim 1, wherein the combustion-supporting gas is oxygen.

5. The method as claimed in claim 1, wherein the combustion-supporting gas is a mixed gas of multiple kinds of gas elements.
